(19) United States
(12) Patent Application Publication
(10) Pub. No.: US 2017/0313564 A1
(43) Pub. Date: Nov. 2, 2017

(54) LIFT SWIVEL UNIT

(71) Applicant: igus GmbH, Koeln (DE)

(72) Inventor: Darius JANSA, Koeln (DE)

(21) Appl. No.: 15/524,481

(22) PCT Filed: Nov. 2, 2015
(86) PCT No.: PCT/EP2015/075385

§ 371 Date: May 4, 2017

(30) Foreign Application Priority Data
Nov. 5, 2014 (DE) 20 2014 105 319.0

(51) Int. Cl. B66F 9/14; B66C 13/08

(52) U.S. Cl. CPC B66F 9/149; B66C 13/08

(57) ABSTRACT

In a lift swivel unit comprising a carrier portion having a through opening through which extends a lift bar rotatable about its longitudinal axis to reduce the structural complication and costs there are provided: a rotary disc plain-bearingly mounted in or at the through opening through the carrier portion as a rotational mounting for the lift bar which is arranged non-rotatably in the rotary disc, a plain-bearing first linear guide integrated in the rotary disc for the lift bar, a first drive unit for driving the rotary disc and a second drive unit fixed to a face of the rotary disc for the linear drive of the lift bar.

### FIELD OF THE INVENTION

The invention concerns a lift swivel unit comprising a carrier portion having a through opening through which extends a lift bar rotatable about its longitudinal axis, a linear guide arranged in or at the through opening through the carrier portion for the lift bar, a rotational mounting connected to the carrier portion for rotatably mounting the lift bar relative to the carrier portion, a first drive unit arranged at the carrier portion for rotationally driving the lift bar and a second drive unit for linearly driving the lift bar.

### BACKGROUND

A disadvantage with known lift swivel units of the above-indicated kind are the complicated and expensive structure, in particular the mounting for the lift bar, and the costs linked thereto.

### SUMMARY

The object of the present invention is to provide a lift swivel unit involving reduced structural complication and lower costs.

According to the invention, in a lift swivel unit of the kind set forth in the opening part of this specification, that object is attained in that it uses as the rotational mounting a rotary disc which is plain-bearingly mounted in the through opening through the carrier portion and in which the lift bar is non-rotatably arranged and in which a first plain-bearing linear guide for the lift bar is integrated, the first drive unit is adapted for driving the rotary disc and the second drive unit fixed at a face of the rotary disc.

The feature that there is arranged in or at the through opening through the carrier portion a plain-bearingly mounted rotary disc as the rotational mounting for the lift bar, in which a plain-bearing linear guide for the lift bar is integrated, considerably simplifies the structural complication in regard to the design configuration of the linear guide of the lift bar and the rotary mounting thereof to the carrier.

It is particularly advantageously provided that at least the regions of the rotary disc, that are plain-bearingly mounted to the carrier portion, and the regions of the first linear guide that are plain-bearingly mounted to the lift bar, comprise a plastic which is compatible with a plain bearing arrangement.

The use of a plain bearing-compatible plastic in the respective mounting regions permits play-free and lubricant-free support and rotational mounting of the rotary disc on the carrier portion as well as play-free and lubricant-free linear guidance of the lift bar by the rotary disc.

In a preferred development of the invention the rotary disc has two disc-shaped parts which can be fixed to each other and which bear in plain-bearingly mounted relationship with flange-like regions against a respective one of the oppositely disposed regions of the through opening through the carrier portion.

In particular the two disc-shaped parts can be in the form of circular discs which are fixed concentrically relative to each other by fixing means, in particular screw connections, and which bear in plain bearing-supported relationship with mutually facing peripheral regions of their faces against the oppositely disposed outer edge regions of the through opening in the carrier portion. Axial prestressing can be adjustable by the fixing means, for example screws arranged axially relative to the disc-shaped parts.

The carrier portion is preferably of a plate-shaped configuration. It thus permits surfaces which are co-planar around the through opening at the outer edge regions of the through opening for plain bearing-supported contact with the flange-like regions of the rotary disc.

The carrier portion can be in the form of a separate component or in the form of a region of a component that is provided with suitable plain bearing surfaces, the component serving as a carrier for the rotary disc and the second drive unit fixed to same.

In a preferred development of the invention the rotary disc has a sprocket cooperating with a toothed belt drivable by an electric motor of the first drive unit. The electric motor can be in particular a stepping motor.

When the rotary disc is composed of two disc-shaped parts the sprocket is arranged on that part which projects at the same side of the carrier portion, at which the first drive unit is disposed.

In a preferred development of the invention at a longitudinal side the lift bar has a toothed portion which cooperates with a gear arranged on the motor shaft of an electric motor of the second drive unit. The teeth of the toothed portion can extend in particular perpendicularly to the longitudinal axis of the lift bar.

In a preferred development of the invention a second plain-bearing linear guide for the lift bar is fixed to the second drive unit at a spacing from the rotary disc. The second linear guide can be in the form of a one-piece plastic linear plain bearing.

Alternatively the second linear guide can have a housing with at least one plastic plain bearing element arranged therein.

The first and possibly second linear guide has a through opening for plain-bearing guidance for the lift bar, from which slots can extend radially outwardly. That allows play-free guidance of the lift bar in the linear guide in question.

Preferably the lift bar is in the form of a quadrangular bar, in particular a quadrangular profile tube, and the plain-bearing linear guide is in the form of a quadrangular linear guide.

In a preferred development of the invention the carrier portion is in the form of a bent sheet metal portion. The individual components of the lift swivel unit can be arranged as an assembly thereon.

In particular the bent sheet metal portion can be of a C-shaped configuration with a longer limb and a shorter limb, wherein the through opening and the rotary disc are arranged in the end region of the longer limb, that projects beyond the shorter limb, and the first drive unit is provided on the shorter limb.

In this design, the part of the rotary disc that is provided with a sprocket is desirably arranged at the inside of the longer limb of the bent sheet metal portion. The electric motor of the first drive unit can be fixed at the outwardly facing side of the shorter limb, in which case the drive shaft of the electric motor extends through the shorter limb and has a gear which is arranged between the limbs and which is disposed at the same height as the sprocket of the rotary disc and cooperates therewith by way of the toothed belt.

Preferably disposed over the gear is a through opening in the longer limb, through which the first drive unit can be fixed to the shorter limb with a tool.

The components of the lift swivel unit according to the invention can be mounted on the other hand at that carrier which has a carrier portion suitable for plain-bearingly mounting the rotary disc, for example a table top or a housing wall.

The rotary disc can thus be mounted to any carrier which has surfaces with suitable plain bearing properties.

The present invention further concerns an assembly or a construction kit for a lift swivel unit which includes the following components: a lift bar, a rotary disc in which the lift bar is non-rotatably arranged and which is suitable for plain-bearingly mounted rotation in or at a through opening of a carrier portion, a plain-bearing linear guide, which is integrated in the rotary disc, for the lift bar, a first drive unit for driving the rotary disc and for rotation of the lift bar, and a second drive unit for the linear drive of the lift bar, that can be fixed to a face of the rotary disc. The specified components can be individually designed as described hereinbefore for the lift swivel unit according to the invention.

### BRIEF DESCRIPTION OF THE DRAWINGS

An embodiment of the present invention is described in greater detail hereinafter with reference to the drawings in which:

FIG. 1 shows a side view of the lift swivel unit;

FIG. 2 shows a view of the lift swivel unit of FIG. 1 from below (in the direction of the arrow II in FIG. 1);

FIG. 3 shows a view of the lift swivel unit of FIG. 1 from above (in the direction of the arrow III in FIG. 1);

FIG. 4 shows an exploded view of the components of the lift swivel unit without the first drive unit; and

FIG. 5 shows an exploded view of the rotary disc of the lift swivel unit.

### DETAILED DESCRIPTION

As can be seen from FIG. 1 of the drawing the lift swivel unit 1 comprises a carrier portion 2 having a through opening, through which extends a lift bar 3 rotatable about its longitudinal axis, a rotary disc 4 supported by plain bearing means in and at the through opening through the carrier portion 2 for rotationally mounting the lift bar 3 to the carrier portion 2, a plain-bearing first linear guide 5, arranged in the rotary disc 4, for the lift bar 3, a first drive unit 6 for the rotational drive of the rotary disc 4 and a second drive unit 8 fixed to a face 7 of the rotary disc 4 for the linear drive of the lift bar 3.

The rotary disc 4 with the plain-bearing first linear guide 5 integrated therein is made from a plain bearing-compatible plastic.

As can be seen from FIGS. 4 and 5 the rotary disc 4 has a first disc-shaped part 9 and a second disc-shaped part 10 which bear in plain bearing-supported relationship with mutually facing end face regions against a respective one of the oppositely disposed outer edge regions of the through opening through the carrier portion 2. The two parts 9 and 10 are respectively made from plastic material in one piece substantially in the form of circular discs.

The first disc-shaped part 9 has a central through opening 11 for guiding the lift bar 3 supported by plain bearing means. Arranged around the through opening 11 are slots 12 which extend radially outwardly therefrom and which allow play-free guidance of the lift bar 3 in the linear guide 5.

The lift bar 3 is in the form of a quadrangular profile tube and the through opening 11 of the linear guide 5 is in the form of a quadrangular linear guide.

In its axial region the second disc-shaped part 10 can also have a through opening aligned with the through opening 11 in the first disc-shaped part, for guiding the lift bar 3 supported by plain bearing means, which opening can also be provided with radially outwardly extending slots 12. This design configuration has the advantage that the plain bearing guidance is provided over a larger portion of the axial extent of the rotary disc 4.

The two disc-shaped parts 9 and 10 can be coaxially fixed together by fixing means, in particular screws 14, and bear in plain bearing-supported relationship with mutually facing peripheral regions of their faces against the oppositely disposed outer edge regions of the through opening in the carrier portion 2. Axial prestressing of the two disc-shaped parts 9 and 10 in relation to the carrier portion 2 can be adjusted by means of the screws 14. Self-securing nuts prevent the parts 9 and 10 from coming loose from each other.

The two disc-shaped parts 9 and 10 are additionally guided axially by fitting pins 30. That provides a higher level of stiffness in relation to torsion of the two parts 9 and 10.

The second disc-shaped part 10 is of an annular configuration and in its radially inward region has an annular shoulder 15 which when the rotary disc 4 is fixed in place extends through the through opening in the carrier portion 2 and can bear with its periphery in plain bearing-supported relationship against the inside wall of the through opening. The above-mentioned through opening for guidance of the lift bar 3 in plain bearing-supported relationship can be arranged in the inner region of the annular shoulder 15.

Provided in the first disc-shaped part 9 and aligned therewith in the annular shoulder 15 of the second disc-shaped part 10 are axially extending openings for screw fixing and axial prestressing.

Provided around the annular shoulder 15 in the second disc-shaped part 10 are axially directed through openings which serve to save on material. The outer edge region, which is continuous in the peripheral direction, of the second disc-shaped part 10 is provided with segment-shaped sliding surfaces 16.

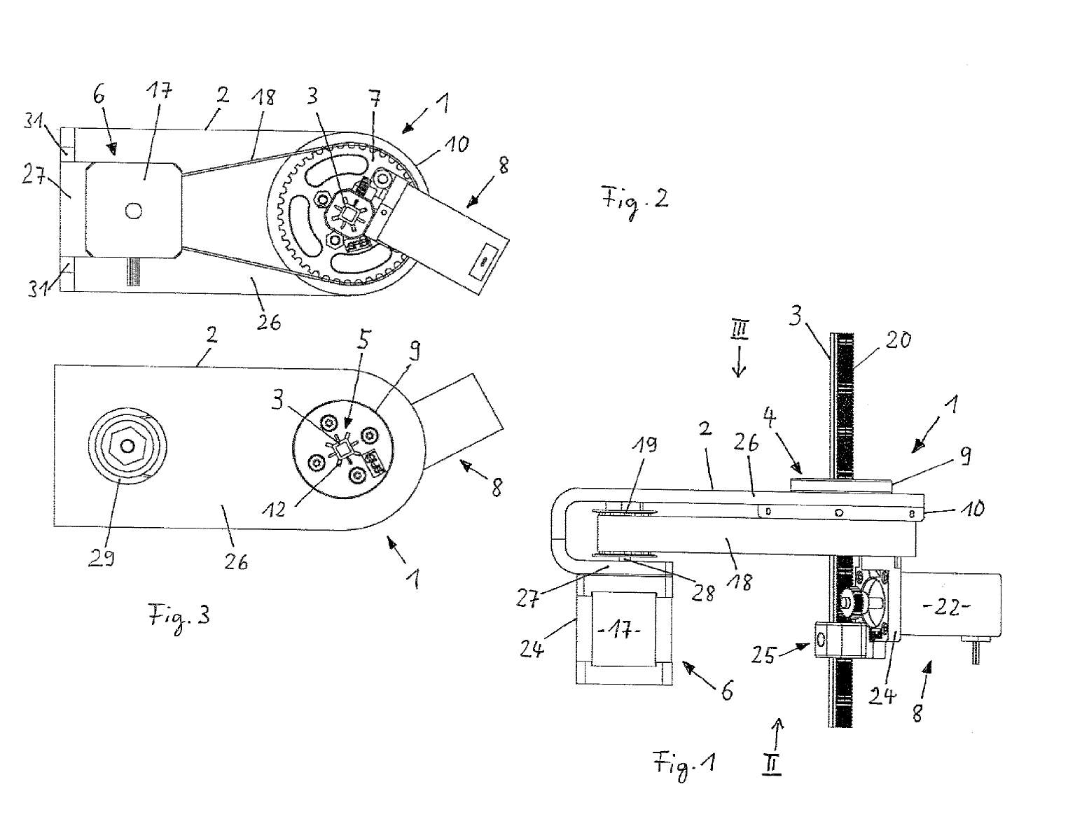

The sprocket 13 on the second disc-shaped part 10 cooperates with a toothed belt 18 drivable by a stepping motor 17 of the first drive unit 6, as can be seen from FIGS. 1, 2 and 4. A gear 19 for driving the toothed belt 18 is provided on the motor shaft 28 of the stepping motor 17.

As can be seen in particular from FIGS. 1 and 4 a long side of the lift bar 3 which is in the form of a quadrangular profile tube has a tooth arrangement 20 comprising teeth extending perpendicularly to the longitudinal axis of the lift bar 3. The tooth arrangement 20 cooperates with a gear 23 arranged on the motor shaft 21 of a stepping motor 22 of the second drive unit 8.

As can be further seen in particular from FIGS. 1 and 4 the stepping motor 22 of the second drive unit 8 is fixed by means of a frame structure 24 to the face 7 of the second disc-shaped part 10 in the region of the sprocket ring 13. Screw bolts which engage through openings in the frame structure 24 and the second disc-shaped part 10 serve for fixing purposes.

As can again be seen in particular from FIGS. 1 and 4 a second plain-bearing linear guide 25 for the lift bar 3 is fixed to the second drive unit 8 at a spacing from the rotary disc 4, that encloses an intermediate space. The second linear guide 25 is in the form of a one-piece plastic linear plain bearing with a quadrangular through opening with slots 12 for the lift bar 3.

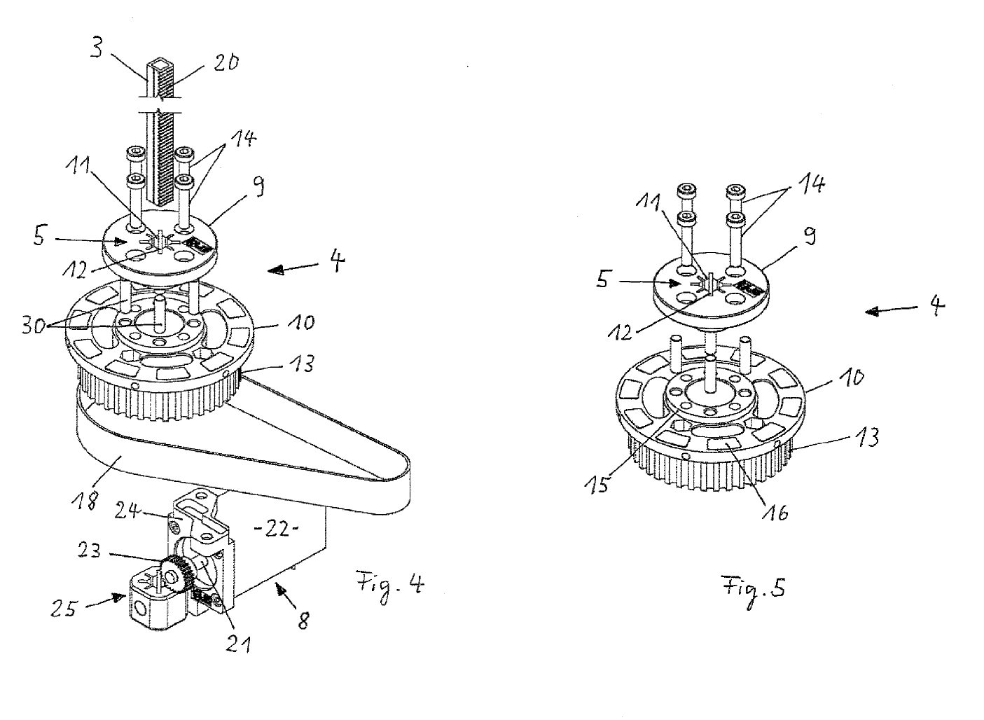

As shown in FIGS. 1 to 3 the carrier portion 2 is in the form of a bent sheet metal portion on which the individual components of the lift swivel unit 1 are arranged as an assembly. The bent sheet metal portion is of a C-shaped configuration with a longer limb 26 and a shorter limb 27, wherein the through opening and the rotary disc 4 are arranged in the end region of the longer limb 26, that projects beyond the shorter limb 27, and the first drive unit 6 is provided on the shorter limb 27.

The region having the sprocket 13 of the second disc-shaped part 10 of the rotary disc 4 is arranged at the inside of the longer limb 26 while the stepping motor 17 of the first drive unit 6 is fixed to the outwardly facing side of the shorter limb 27, the motor shaft 28 of the stepping motor 17 extending through the shorter limb 27. The gear 19 disposed on the motor shaft 28 is arranged between the limbs 26 and 27 and is at the same height as the sprocket 13 of the rotary disc 4.

Provided in the longer limb 26 over the gear 19 is a through opening 29 through which the first drive unit 6 arranged on the shorter limb 27 can be fixed with a tool.

The transitional region between the longer limb 26 and the shorter limb 27 has a flat outwardly facing region which extends perpendicularly relative to the limbs 26 and 27 and serves for fitment to a wall of a component. Fixing means 31 are provided in the above-mentioned transitional region for fixing to a wall.

In addition sensors and a signal transmission and processing device for sensor signals can be provided for establishing the rotational angle of the rotary disc 4.

### LIST OF REFERENCES

1 lift swivel unit
2 carrier portion
3 lift bar
4 rotary disc
5 first linear guide
6 first drive unit
7 face
8 second drive unit
9 first disc-shaped part
10 second disc-shaped part
11 through opening
12 slot
13 sprocket
14 screw
15 shoulder
16 slide surface
17 stepping motor
18 toothed belt
19 gear
20 tooth arrangement
21 motor shaft
22 stepping motor
23 gear
24 frame structure
25 second linear guide
26 longer limb
27 shorter limb
28 motor shaft
29 through opening
30 fitting pin
31 fixing means

What is claimed is:

1. A lift swivel unit comprising:
a carrier portion having a through opening through which extends a lift bar rotatable about its longitudinal axis,
a rotary disc plain-bearingly mounted in or at the through opening through the carrier portion as a rotational mounting for the lift bar which is arranged non-rotatably in the rotary disc,
a plain-bearing first linear guide integrated in the rotary disc for the lift bar,
a first drive unit for driving the rotary disc; and a second drive unit fixed to a face of the rotary disc for the linear drive of the lift bar.

2. The lift swivel unit according to claim 1 wherein at least the regions of the rotary disc, that are plain-bearingly mounted to the carrier portion, and the regions of the first linear guide that are plain-bearingly mounted to the lift bar, comprise a plain bearing-compatible plastic.

3. The lift swivel unit according to claim 1, wherein the rotary disc has two disc-shaped parts which can be fixed to each other and which bear in plain-bearing relationship with flange-like regions against a respective one of the oppositely disposed regions of the through opening through the carrier portion.

4. The lift swivel unit according to claim 1, wherein the two disc-shaped parts of the rotary disc are respectively in one piece and the plain-bearing first linear guide for the lift bar is provided in at least one of said parts.

5. The lift swivel unit according to claim 1, wherein the carrier portion is of a plate-shaped configuration.

6. The lift swivel unit according to claim 1, wherein the rotary disc has a sprocket cooperating with a toothed belt drivable by an electric motor of the first drive unit.

7. The lift swivel unit according to claim 2, wherein the sprocket is arranged at that disc-shaped part which projects at the same side of the carrier portion, at which the electric motor of the first drive unit is disposed.

8. The lift swivel unit according to claim 1, wherein at a longitudinal side the lift bar has a portion which is provided with a tooth arrangement and which cooperates with a gear arranged on the motor shaft of an electric motor of the second drive unit.

9. The lift swivel unit according to claim 1, wherein a second plain-bearing linear guide for the lift bar is fixed to the second drive unit at a spacing from the rotary disc.

10. The lift swivel unit according to claim wherein the second linear guide is in the form of a one-piece plastic linear plain bearing.

11. The lift swivel unit according to claim 9, wherein the second linear guide has a housing with at least one plastic slide element arranged therein.

12. The lift swivel unit according to claim 1, wherein the plain-bearing mounted linear guide has a through opening for plain-bearing guidance of the lift bar, from which slots extend radially outwardly.

13. The lift swivel unit according to claim 1, wherein the lift bar is in the form of a quadrangular bar, in particular a quadrangular profile tube, and the plain-bearing linear guide is in the form of a quadrangular linear guide.

14. The lift swivel unit according to claim 1, wherein the carrier portion is in the form of a bent sheet metal portion on which the individual components of the lift swivel unit are arranged as an assembly.

15. The lift swivel unit according to claim 14, wherein the bent sheet metal portion is of a C-shaped configuration with a longer limb and a shorter limb, wherein the through opening and the rotary disc are arranged in the end region of the longer limb, that projects beyond the shorter limb, and the first drive unit is provided on the shorter limb.

16. The lift swivel unit according to claim 1, wherein the carrier portion is formed as a region of a component, which region is provided with plain bearing surfaces for the rotary disc and a through opening.

17. An assembly for the lift swivel unit according to claim 1, comprising:
a lift bar;
a rotary disc in which the lift bar is non-rotatably arranged and which is suitable for plain-bearingly mounted rotation in or at a through opening of a carrier portion;
a plain-bearing first linear guide, which is integrated in the rotary disc, for the lift bar;
a first drive unit for driving the rotary disc and for rotation of the lift bar; and
a second drive unit for the linear drive of the lift bar, that can be fixed to a face of the rotary disc.
